(19) United States
(12) Patent Application Publication
(10) Pub. No.: US 2009/0086364 A1
(43) Pub. Date: Apr. 2, 2009

(54) PER WEDGE WORF DETERMINATIONS FOR DISK DRIVE

(75) Inventor: Anton Gerasimov, Santa Clara, CA (US)

Correspondence Address: SCHWEGMAN, LUNDBERG & WOESSNER/TOSHIBA, P.O. BOX 2938, MINNEAPOLIS, MN, 55402, US

(73) Assignee: Kabushiki Kaisha Toshiba1-1, tokyo (JP)

(21) Appl. No.: 11/864,627

(22) Filed: Sep. 28, 2007

(51) Int. Cl. G11B 5/596

(52) U.S. Cl. 360/77.04

(57) ABSTRACT

A method for locating a track on a disk surface having a plurality of wedges of servo information includes demodulating servo information for a first servo wedge, and determining a correction factor for a written in repeatable runout for the servo information for the first servo wedge before demodulating servo information for a second servo wedge. A machine-readable medium provides instructions that perform the above method. A disk drive includes a processor disk that performs the above method and generates a signal to position a transducer over a desired track.

### TECHNICAL FIELD

A disk drive is an information storage device. A disk drive includes one or more disks clamped to a rotating spindle, and at least one head for reading information representing data from and/or writing data to the surfaces of each disk. More specifically, storing data includes writing information representing data to portions of tracks on a disk. Data retrieval includes reading the information representing data from the portion of the track on which the information representing data was stored. Disk drives also include an actuator utilizing linear or rotary motion for positioning transducing head(s) over selected data tracks on the disk(s). A rotary actuator couples a slider, on which a transducing head is attached or integrally formed, to a pivot point that allows the transducing head to sweep across a surface of a rotating disk. The rotary actuator is driven by a voice coil motor.

Disk drive information storage devices employ a control system for controlling the position of the transducing head during read operations, write operations and seeks. The control system includes a servo control system or servo loop. The function of the head positioning servo control system within the disk drive information storage device is two-fold: first, to position the read/write transducing head over a data track with sufficient accuracy to enable reading and writing of that track without error; and, second, to position the write element with sufficient accuracy not to encroach upon adjacent tracks to prevent data erosion from those tracks during writing operations to the track being followed, or to stop an ongoing write operation if continued writing might encroach upon an adjacent track.

A servo control system includes a written pattern on the surface of a disk called a servo pattern. The servo pattern is read by the transducing head. Reading the servo pattern results in positioning data or a servo signal used to determine the position of the transducing head with respect to a track on the disk. In one servo scheme, positioning data can be included in servo wedges, each including servo patterns. Information included in the servo patterns can be used to generate a position error signal (PES) that indicates the deviation of the transducing head from a desired track center. The PES is also used as feedback in the control system to provide a signal to the voice coil motor of the actuator to either maintain the position of the transducing head over a desired track centerline or to reposition the transducing head to a position over the centerline of a desired track.

In an ideal disk drive, the tracks of the disk are non-perturbed circles situated about the center of the disk. As such, each of these ideal tracks includes a track centerline that is located at a known constant radius from the disk center. In an actual disk drive, however, it is difficult to write non-perturbed circular tracks to the disk. That is, due to certain problems (e.g., vibration, bearing defects, inaccuracies in the STW and disk clamp slippage), the tracks are generally written differently from the ideal non-perturbed circular shape. Positioning error created by the perturbed nature of these tracks is known as written-in repeatable runout (WRRO).

The perturbed shape of these tracks complicates the transducer positioning during read and write operations or self servowrite because the servo control system needs to continuously reposition the transducer during track-following to keep up with the constantly changing radius of the track centerline with respect to the center of the spinning disk. Furthermore, the perturbed shape of these tracks can result in track squeeze and track misregistration errors during read and write operations and self servo write.

Disk drive manufacturers have developed techniques to measure the WRRO and produce compensation values.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is an exploded view of a disk drive that uses example embodiments described herein.

FIG. 2 is a partial detailed view of a disk from the disk drive shown in FIG. 1 that includes a servo pattern that includes servo bursts, according to an example embodiment.

FIG. 3 is a representation of another arrangement of servo bursts null pattern that could be used in a servo wedge, according to an example embodiment.

FIG. 4 is a schematic diagram of a disk drive and that includes an electrical schematic for determining the location of at least one servo burst edge in the servo wedge and producing a drive signal to the actuator driver of the disk drive, according to an example embodiment.

FIG. 5 is a schematic diagram that shows a controller or microprocessor and includes discrete frequency domain signals according to an example embodiment.

FIG. 6A is a schematic diagram that shows relative position of servo wedges and written data to corresponding code servo routine execution times, according to an example embodiment.

FIG. 6B is a schematic diagram that shows relative position of servo wedges and written data to corresponding code servo routine execution times, according to another example embodiment.

FIG. 7 is a flow chart of a method for determining the Wedge Offset Reduction Field (WORF) values on a per-wedge basis, according to an example embodiment.

FIG. 8 is a flow chart of another method for determining the WORF values on a per-wedge basis, according to an example embodiment.

FIG. 9 is a block diagram of a computer system that executes programming for performing the methods discussed herein, according to an example embodiment

The description set out herein illustrates the various embodiments of the invention and such description is not intended to be construed as limiting in any manner.

### DETAILED DESCRIPTION

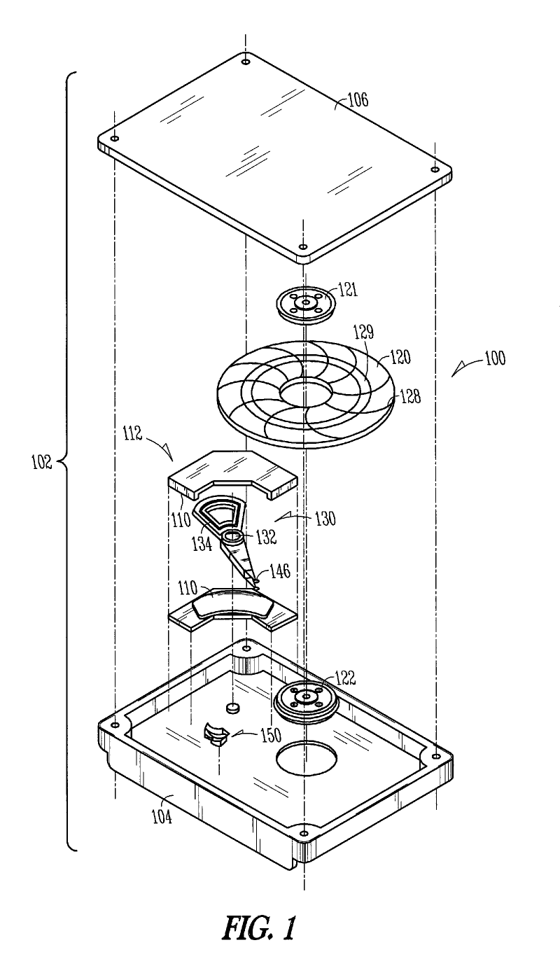

FIG. 1 is an exploded view of disk drive 100 that uses various embodiments of the present invention. The disk drive 100 includes a housing 102 including a housing base 104 and a housing cover 106. The housing base 104 illustrated is a base casting, but in other embodiments a housing base 104 can comprise separate components assembled prior to, or during assembly of the disk drive 100. A disk 120 is attached to a hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 146. The transducing head 146 includes a magnetic transducer adapted to read data from and write data to the disk 120. In other embodiments, the transducing head 146 includes a separate read element and write element. For example, the separate read element can be a magneto-resistive head, also known as a MR head. It will be understood that multiple head 146 configurations can be used.

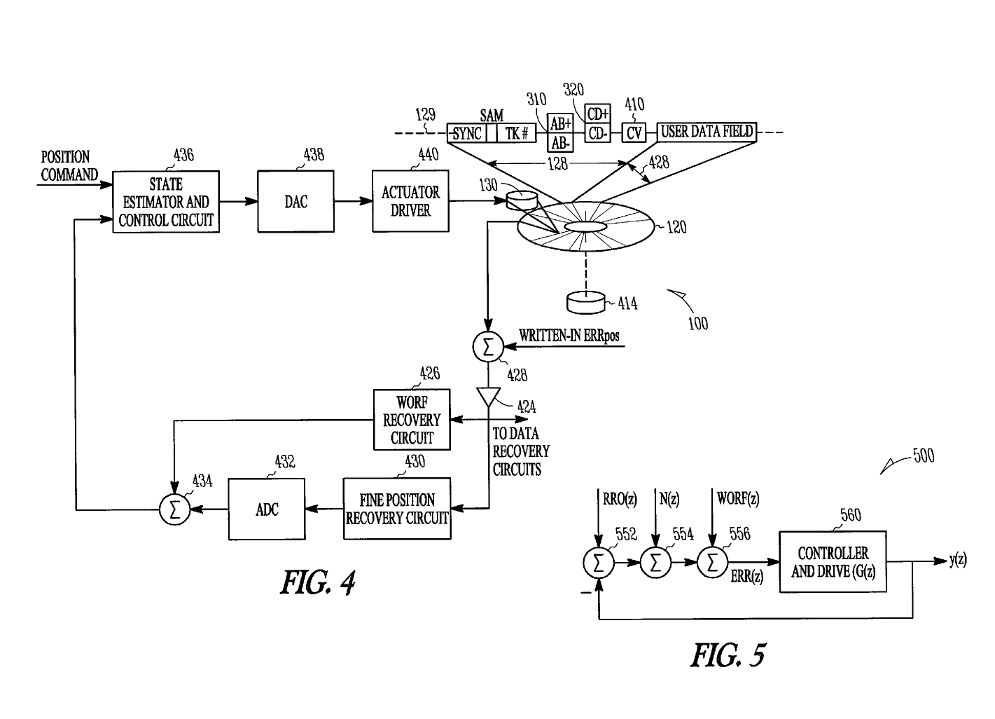

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132. The actuator accelerates in one angular direction when current is passed through the voice coil 134 and accelerates in an opposite direction when the current is reversed, allowing for control of the position of the actuator 130 and the attached transducing head 146 with respect to the disk 120. The VCM 112 is coupled with a servo system (shown in FIG. 4) that uses positioning data read by the transducing head 146 from the disk 120 to determine the position of the transducing head 146 over one of a plurality of tracks on the disk 120. The servo system determines an appropriate current to drive through the voice coil 134, and drives the current through the voice coil 134 using a current driver and associated circuitry (shown in FIGS. 4 and 5). It should be noted that in some embodiments transducing includes two separate elements. One element is for reading information representing data and reading positional information or servo information. This element is known as a read element. The other element, in these embodiments, is for writing information representing data and is known as a write element. One example of such a transducing head is a magnetoresistive (MR) transducing head.

Each side of a disk 120 can have an associated head 146, and the heads 146 are collectively coupled to the rotary actuator 130 such that the heads 146 pivot in unison. The invention described herein is equally applicable to devices wherein the individual heads separately move some small distance relative to the actuator. This technology is referred to as dual-stage actuation (DSA).

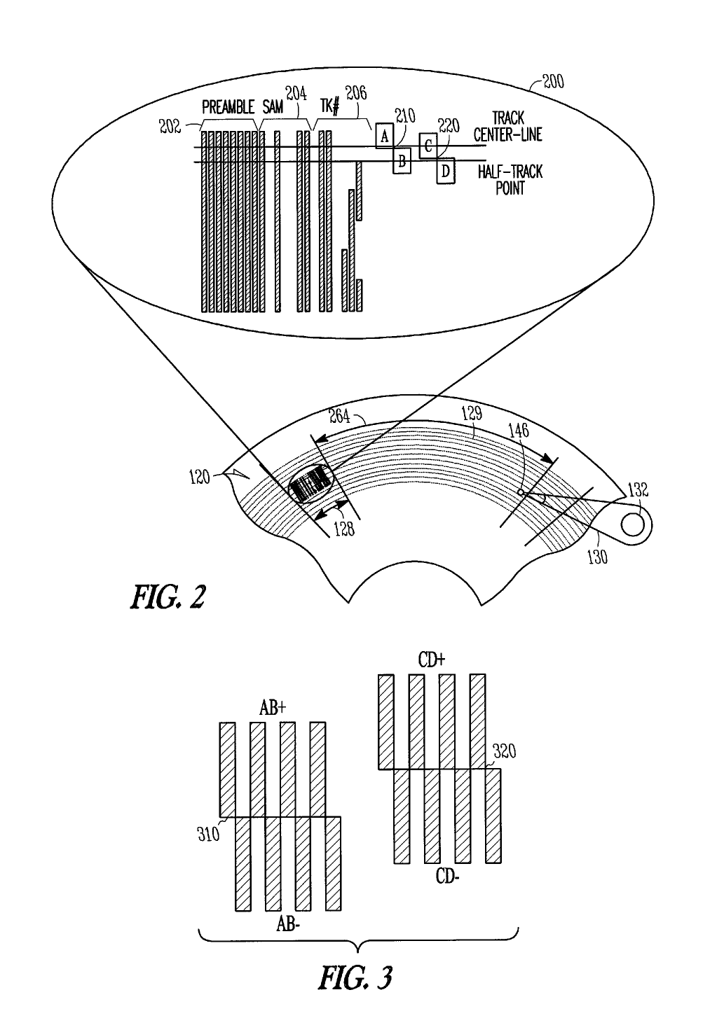

One type of servo system is an embedded, servo system in which tracks on each disk surface used to store information representing data contain small segments of servo information. The servo information, in some embodiments, is stored in radial servo sectors or servo wedges shown as several narrow, somewhat curved spokes 128 substantially equally spaced around the circumference of the disk 120. It should be noted that in actuality there may be many more servo wedges than as shown in FIG. 1. The servo wedges 128 are further detailed in FIGS. 2, 3 and 4 and in the discussions associated with those FIGS.

The disk 120 also includes a plurality of tracks on each disk surface. In FIG. 1, the plurality of tracks is depicted by multiple tracks, such as track 129, shown on the surface of the disk 120. The servo wedges 128 traverse the plurality of tracks, such as track 129, on the disk 120. The plurality of tracks, in some embodiments, may be arranged as a set of substantially concentric circles. Data is stored in fixed sectors along a track between the embedded servo wedges 128. The tracks on the disk 120 each include a plurality of data sectors. More specifically, a data sector is a portion of a track having a fixed block length and a fixed data storage capacity (e.g. 512 bytes of user data per data sector). The tracks toward the inside of the disk 120 are not as long as the tracks toward the periphery of the disk 110. As a result, the tracks toward the inside of the disk 120 can not hold as many data sectors as the tracks toward the periphery of the disk 120. Tracks that are capable of holding the same number of data sectors are grouped into a data zones. Since the density and data rates vary from data zone to data zone, the servo wedges 128 may interrupt and split up at least some of the data sectors. The servo sectors 128 are typically recorded with a servo writing apparatus at the factory (called a servo-writer), but may be written (or partially written) with the disk drive's 100 transducing head(s) 146 in a self-servowriting operation.

FIG. 2 shows a portion of a disk 120 having at least one servo wedge 128. Each servo wedge 128 includes information stored as regions of magnetization or other indicia, such as optical indicia. A servo wedge 128 can be longitudinally magnetized (for example, in the magnified portion of FIG. 2 a servo pattern 200 includes cross-hatched blocks magnetized to the left and white spaces magnetized to the right, or vice-versa) or alternatively perpendicularly magnetized (e.g., the cross-hatched blocks are magnetized out of the page and the white spaces are magnetized into the page, or vice-versa). Servo patterns 200 contained in each servo wedge 128 are read by the transducing head 146 as the surface of the spinning disk 120 passes under the transducing head 146. The servo patterns 200 can include information which can be used to identify a data sector contained in a data field 264. For example, the servo pattern 200 can include digital information such as a preamble 202, a servo address mark (SAM) 204, a track identification number 206. The servo pattern 200 also includes a set of servo bursts. As shown in FIG. 2, the set of servo bursts include an A servo burst, a B servo burst, a C servo burst, and a D servo burst. There is a servo burst edge 210 between the A burst and the B burst, and a servo burst edge 220 between the C burst and the D burst. The pattern shown is a quadrature type pattern. In some embodiments, a disk drive will include a single column of each type of servo burst in each servo wedge 128. Each column corresponds to a radial of the disk. In some embodiments, the servo wedge 128 will also include other information such as a wedge number. This can be a single bit to designate an index wedge (wedge #0), or the SAM may be replaced by another pattern (referred to as a servo index mark or SIM), or the wedge may contain a few low-order bits of the wedge number or a complete wedge number.

There are many different patterns for servo bursts. FIG. 3 shows another servo burst pattern which is associated with a null pattern. This pattern shows four servo bursts and it should be understood that this may also be repeated in columns so as to produce several radial lines of AB+, AB−, CD+ and CD− bursts on the disk in each servo wedge, such as servo wedge 128, on the disk. The servo burst pattern results in a servo burst edge 310 between the AB+ and AB− servo bursts, and a servo burst edge 320 between the CD+ and CD− servo bursts in the null pattern.

In an ideal drive, one of the burst edges may be at the center of a track or at a known distance from the center of the track. In an ideal drive, the servo pattern is read and demodulated and the distance from a selected servo burst edge is determined. A position error signal (PES) indicative of the distance from the track center or the servo burst edge is generated and used to move the read head or write head to a position over the center of the desired track. In most drives, although the write head (from a servo writer, a media writer or the product) is carefully controlled during the servo writing, it is not always perfect and the servo data placed on the disk may not correspond to the tracks as in the ideal situation. It is nearly impossible to always perfectly position a head with respect to a track for each rotation of a disk. There is almost always a noticeable offset between the desired position and the actual position of the head with respect to the disk. This may result in a written servo pattern having a portion of the pattern that is slightly misplaced. This can lead to written-in runout. Written-in runout can be thought of as the offset between the “actual” centerline, or desired radial center, of a track and the centerline that would be determined by a head reading the written servo pattern. Written-in runout can lead to servo performance problems, wasted space on a disk and, in a worst case, unrecoverable or irreparably damaged data.

It is desirable to determine the distance between the desired track centerline (either a read track centerline or write track centerline) and the apparent centerline obtained from demodulating the burst pattern. Knowing this distance, all or at least a portion of the synchronous written-in runout can be removed from the servo pattern as written. This determined distance can be stored in the servo wedges for a track, or in memory associated with the disk drive. When there are values associated with each wedge, the stored distance data is referred to herein as the Wedge Offset Reduction Field (WORF) data. WORF data can be, for example, a digital number placed after a servo wedge on a given track that includes an amount that should be added to, or subtracted from, the PES value for that wedge obtained from demodulating the servo bursts. Alternatively, WORF data can also be stored in memory such as SRAM, DRAM, or flash. The WORF data can be used to compensate for the misplacement of the burst edges used to determine a track centerline. The WORF value associated with a wedge can be read and added to the value to the computed PES, and presumably follow a more accurate track. Of course, the WORF data may be a negative or positive value.

FIG. 4 is a schematic diagram of a disk drive 100 and that includes an electrical schematic for determining the location of at least one servo burst edge in the servo wedge 128 and producing a drive signal to the actuator driver of the disk drive, according to an example embodiment. As shown in FIG. 4, the disk 120 includes a servo wedge 128 that includes a null type servo burst pattern that includes the AB+, AB− burst edge 310 and the CD+, CD− burst edge 320. It should be noted that this invention will also work in disk drives that include other types of servo patterns, such as a quadrature servo pattern. Also shown in FIG. 4, is a storage field 410 for storing a correction value of the distance the at least one of the AB+, AB− burst edge 310 or the CD+, CD− burst edge 320 is from the ideal track. The correction value or WORF value, in some embodiments, may also be stored in memory such as SRAM, DRAM, or flash. Of course, in an embodiment that features quadrature type servo pattern, the WORF value will correspond to a distance from at least one of an AB burst edge 210 (shown in FIG. 2) or a CD burst edge 220 (shown in FIG. 2). The disk 120, which is one kind of media, includes a plurality of tracks 129 (shown also in FIG. 1), a data sector, and at least one wedge of servo information 128 written to the media. The tracks 129 pass through both the data sector and the at least one wedge of servo information 128. The wedge of servo information 128 includes a first servo burst edge 310, a second servo burst edge 320.

The actuator 130 is driven by an actuator driver 440. The actuator driver 440 delivers current to the voice coil motor (shown in FIG. 1). In operation, minute electrical signals induced from recorded magnetic flux transitions are amplified by a preamplifier 424 and then delivered to conventional disk drive data recovery circuits (not shown). The disk drive 100 includes a servo system 400 that is used to determine the location of a transducer. The servo system 400 is a feedback loop that measures the position of the transducing head and produces a drive current to input to the voice coil motor of the actuator to drive the transducing head to a position over a desired track. The servo system 400 includes a wedge offset reduction field (WORF) circuit 426 and a fine position recovery circuit 430. An actual location signal is determined by a transducing head and is summed with an error position signal and corrected with at least one of the WORF values associated with the AB+, AB− burst 310 or the CD+, CD− burst value 320. The signal is then used to produce a drive current at the actuator driver 440. Now turning to FIG. 4, the servo system will be discussed in more detail. The WORF circuit 426 recovers a digital burst correction value or WORF value from the WORF field 410 in the servo wedge 128 of the disk 120. In an alternative embodiment, the WORF value could be stored in memory.

A summing node 428 is also included in a signal path downstream from the preamplifier 424 and denotes addition of an unknown position error component or repeatable runout (RRO) which was written into the servo wedge 428 during conventional servo writing operations at a laser-interferometer-based servo writer station. This position error RRO is added to relative amplitude values read from the fine position AB+, AB− burst and the CD+,CD− burst and recovered as a sum by a fine position recovery circuit 430. The analog signal from the fine position recovery circuit 430 is digitized and a partial response maximum likelihood digital detector is used to determine the burst locations. These relative amplitudes (corrupted by the written-in position error RRO) are then quantized by an analog to digital converter 432 and supplied to a head position controller circuit 436. In the data stream from the converter 432, a summing node 434 combines a WORF value as read from the correction value field or WORF field 410 of the present servo sector 128 with the digitized position value in order to cancel out the position error RRO. The controller circuit 436 receives head position command values from other circuitry within the disk drive 100 and combines the command values with the quantized and corrected head position values to produce a commanded actuator current value. This commanded current value calculated by node 436, converted into an analog value by a digital to analog converter 438, and applied to control an actuator driver circuit 440 which operates the rotary actuator 130 to adjust the position of the head relative to the data track 129 being followed.

The WORF value or correction value for each wedge is determined at each servo wedge on the disk for a particular track. In other words, the WORF value is determined in “real time” on a per wedge basis. The WORF value for a servo wedge is determined before the next servo wedge on the disk is encountered. The disk drive 100 (shown in FIG. 1) includes a controller or microprocessor that reads and demodulates the servo pattern and produces a PES. The controller or microprocessor can be dedicated to these servo tasks or a portion of the controller or microprocessor can be used to perform these servo operations.

FIG. 5 is a discrete model 500 of the disk drive system shown in FIGS. 1 and 4 and illustrates some of the principles and aspects of an example embodiment. In FIG. 5, the disk drive 100 including its on-board head position servo controller 436 and associated circuitry, is modeled as, but not limited to, a discrete time dynamic system G(z) within block 560. In this exemplary model 500, let z represent the discrete-time time advance operator as is commonly used to transform continuous time systems to discrete time systems and let the Z-transform of the sampled time series rro(t) be represented as RRO(z). The dynamic system is subjected to an unknown repeated disturbance RRO(z) added at a summing node 552. Another unknown disturbance N(z), which is assumed zero mean noise, is added at a summing node 554 to the head position signal. Finally, a specified correction signal WORF(z) is added to the disturbed head position signal at a summing node 556. These three influences produce a combined influence ERR(z) which is the error term that drives the model 500. The resulting closed loop transfer function may be defined as:

ERR(z)=WORF(z)+N(z)+RRO(z)−G(z)·ERR(z)

which may be rearranged as:

WORF(z)+N(z)+RRO(z)=ERR(z)·[1+G(z)];

The RRO signal is, by definition, periodic. Being periodic, it is discrete in the frequency domain and can be represented as a finite length z-polynomial. Since it repeats every revolution of the disk spindle, it can be expressed as a summation of the various harmonics of the spindle. In fact, the only parts of rro(t) that exist are those that occur at ωᵢ, i=0 to M/2 where M is the number of servo position samples per revolution. Since G(z) is a linear system excited by a periodic signal rro(t), the only parts of G(z) of interest here are those at each ωᵢ. The whole system is treated as a summation of discrete systems, each operating at ωᵢ and solve each individually.

For a given ωᵢ, the calculation of WORF(jωᵢ) is straight forward, by measuring ERR(jωᵢ) (via discrete Fourier transform (DFT) or similar method), and knowing 1+G(jωᵢ), we calculate RRO(jωᵢ) from:

WORF(jωᵢ)+N(Jωᵢ)+RRO(jωᵢ)=ERR(jωᵢ)−[1+G(jωᵢ)];

The process of taking DFTs of err(t) at each ωᵢ and scaling each by the corresponding 1+G(jωᵢ) is the same as convolving err(t) with a kernel made from the response of 1+G(z) evaluated at each ωᵢ. Thus, we convolve the signal err(t) with the kernel to yield:

worf(t)+n(t)+rro(t)=err(t) [symbol] kernel

where [symbol] represents the convolution operator.

In accordance with principles and aspects of the present invention, the impact of the zero mean noise term, n(t) is minimized by synchronously averaging, or low pass filtering with an asymptotically decreasing time constant, either err(t), or err(t)-worf(t), for multiple revolutions of the spindle. The number of revolutions necessary is dependent upon the frequency content of the n(t) term. An n(t) having significant spectra near the spindle harmonics will require more revolutions of data filtering to sufficiently differentiate the spectra of rro(t) from n(t). In the presence of sufficient filtering, n(t) becomes small and the left side of the above equation reduces to:

worf(t)+rro(t)

which is the error between our calculated WORF values and the RRO values themselves. This format lends itself to an iterative solution:

worf(t)ₒ=O;

worf(t)ₖ₊₁=worf(t)ₖ+α·err(t)ₖ [symbol] kernel;

where α is a constant near unity selected to yield a convergence rate that is forgiving to mismatches between the actual transfer function and that used to generate the kernel. It is also possible that the value of α could vary from iteration to iteration.

In accordance with principles and aspects of the present invention, the kernel is derived for each different disk drive product, by a process of either control system simulation or by injecting identification signals into the servo control loop and measuring responses to those signals. In some embodiments, a separate kernel can be determined for each manufactured drive, during the post-assembly manufacturing process steps. It is even possible to use a separately determine kernel for each head, or to even multiple kernels for each head, one for each of a multiple of radial zones on each head.

In one embodiment, two WORF values are used in demodulating a position error signal (PES). In one example embodiment, the method would associate one offset or WORF value with the placement-error of each of the two burst-edges, such as 210, 220, or 310, 320 (shown in FIGS. 1-4). The offset or WORF value would be added to the portion of the position error signal (PES) that was due to its corresponding burst-pair (or burst-difference). If only one of the two burst-edges was used to determine the raw PES at any time, then only one of the two offset or WORF values would be used. If a linear combination of values corresponding to the two burst-edges, such as 210, 220, or 310, 320 (shown in FIGS. 1-4), was used, then the same weighting of the two offset or WORF values would be added to the raw PES.

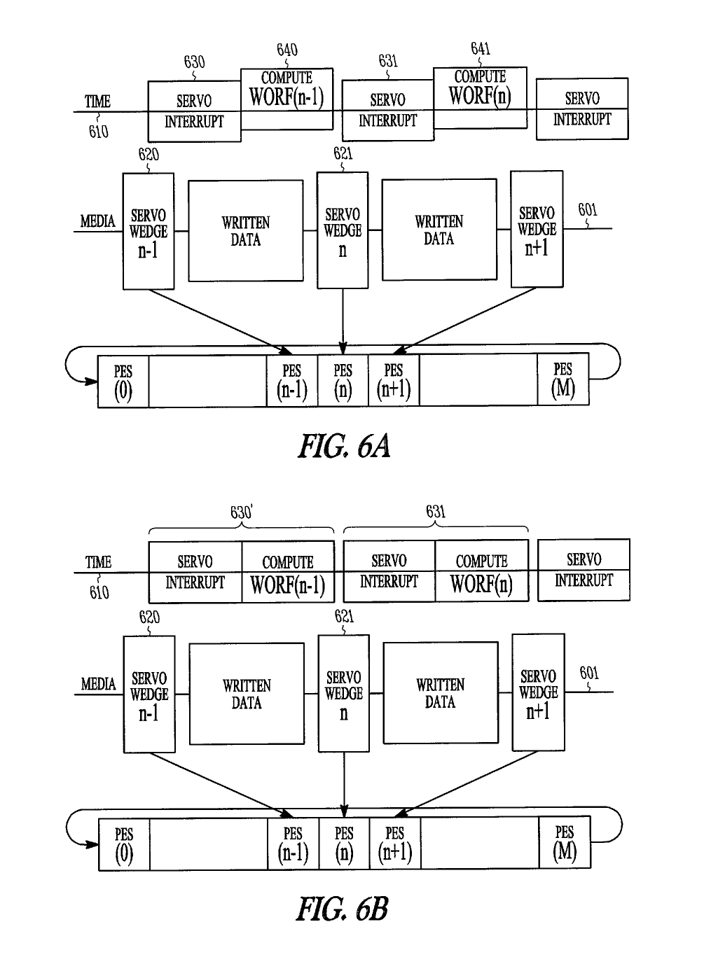

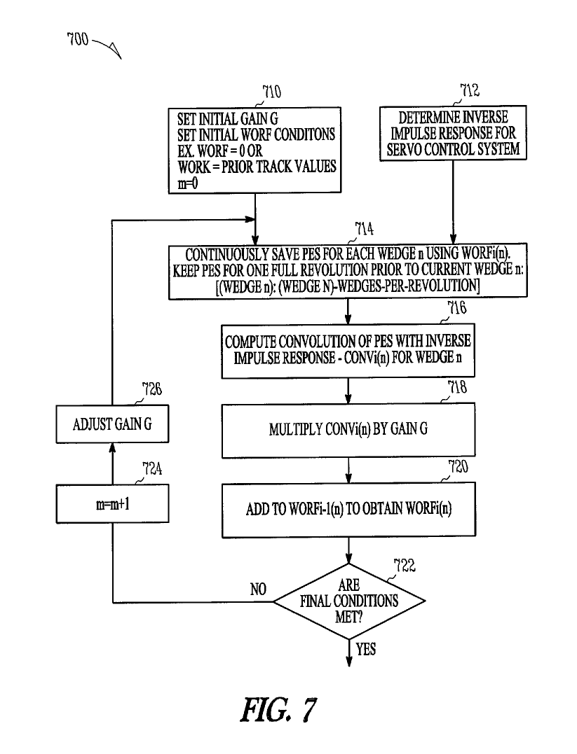

FIG. 6A is a schematic diagram that shows such a relative position of servo wedges and written data on a track 601 of the disk media and corresponding time domain sequence 610 for performing operations, according to an example embodiment. When a servo wedge 620 is encountered, the servo information is read and processed during a servo interrupt time 630. The servo information is read and processed before the next servo wedge 621 is encountered. When the servo wedge 621 is encountered, the servo information is read and processed during a servo interrupt time 631. This process is repeated as the transducing head passes over the disk. Determining the WORF value also requires an amount of processing time 640 (designated compute WORF 640 in FIG. 6A). For example, the amount of time for computing WORF 640 occurs between the servo interrupt 630 time and the servo interrupt time 631. FIG. 6A also includes servo interrupt time 632 and a compute WORF time 641 that occurs between the servo interrupts 631 and 632. Of course, this time domain sequence repeats all along a track 610 of the disk where the servo wedges 620, 621, and 622 are spaced.

FIG. 6B is a schematic diagram that shows relative position of servo wedges and written data on the disk media corresponding time domain sequence 610 for performing operations, according to another example embodiment. Again, the time domain sequence 610 is related to the occurrence of the servo wedges and written data on a track 601 of the disk. As shown in FIG. 6B, the WORF computation can be performed as part of the servo interrupt itself. Thus, the determination of the WORF value is done on a per wedge basis and can be done as part of the servo interrupt process or could be a separate routine executed after the servo interrupt.

During the compute WORF times, certain operations must take place in order to compute WORF values on a per wedge basis. Generally, the operations include measuring the error transfer function of a system and determining corresponding inverse impulse response (done only once, possibly during self-test and does not have to be re-done on either per-track of per-wedge basis) and correcting the PES for a given track. The inverse impulse response (inverse transfer function) may be obtained in a variety of ways. Furthermore, the inverse impulse response may be obtained for each transducer in the disk drive. The other step includes collecting PES information for at least as many wedges prior, and including to the current wedge, as there are wedges in one disk revolution. A circular convolution of those two quantities or these two arrays in time domain is performed which yields a correction value to be applied to the position so that the result is effectively circular tracks, as opposed to noncircular tracks produced by a servo writer or a self servo write process.

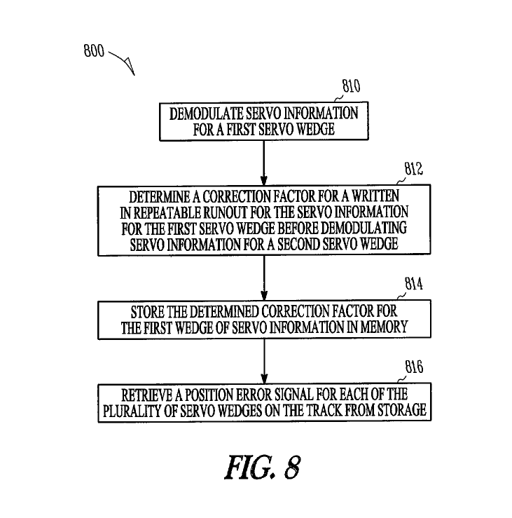

FIG. 7 is a flow chart of a method 700 for determining the WORF value, according to an example embodiment of the invention. The WORF value is an error correction value for the written in run out associated with the written servo pattern at the servo wedge. The method 700 requires a determination of an inverse impulse response function of the servo control system 710. The method 700 also requires the setting of initial gain and initial WORF values 712 for each invocation of the method 700. The initial WORF value can be set either to zero when there are no other WORF values. In the alternative, the initial WORF value can be set to a non-zero values, such as final WORF value from the previous track, if the written in run out (“RRO”) is known to be similar for adjacent track locations. The initial WORF value could also be the WORF value determined for the immediately prior servo wedge on the same track.

The method 700 also includes continuously saving the position error signal (“PES”) for each servo wedge around a track 714. These values are needed to perform the convolution of all the PES values to as part of determining the written in run out (WRRO) associated with the servo information of the servo wedge. More specifically, the PES for each wedge n using WORFᵢ₍ₙ₎ is stored in a buffer. The PES values associated with the wedges in one full revolution prior to the current wedge n are stored in the buffer. The PES is determined as part of servo demodulation, during the time when a processor is processing operations in response to a servo interrupt. In one embodiment, the decoded PES is continuously saved for each servo wedge around a track into a circular buffer. Using a circular buffer, all the values for the PES associated with each of the wedges around the disk for a certain track can be retrieved from the circular buffer. In the method 700, the WORF value for an individual servo wedges n is then computed as a circular convolution (denoted as CONVi(n)) of PES for the last revolution prior to next servo wedge using the inverse impulse response of the system, as depicted by reference number 716.

The method 700 also includes multiplying the circular convolution, CONVi(n), by a variable gain G, as depicted by reference number 718. Variable gain G, in some embodiments, is a function of the number of wedges m processed from the start of current WORF computation procedure. The gain G may also be a function of the level track misregistration (“TMR”) or repeatable run out (“RRO”) achieved during the current WORF procedure. Higher current levels of TMR or RRO may justify higher gain G values while lower levels of TMR or RRO may justify lower gain G values. Finally gain G could be a function of current revolution number equal to

G=1/(Rev) or G=1/(Rev+1),

where Rev is the number of full disk revolutions from the start of the current WORF computation procedure. Other functions are possible as well. The value of the gain should be decreasing for higher processed wedge numbers m to ensure reduced effects of nonrepeatable run out (“NRRO”) and convergence of WORF values to the correct estimates of WRRO of the servo track. This variable gain iterative procedure is less sensitive to impulse response measurement and/or modeling errors and to non-linearities of the control system and PES decoding.

WORFcurrent(n)=CONVi(n)*G

The calculated WORF value for the current wedge n is then added to the existing WORF values, as depicted by reference number 720, and will be used as WORF correction next time PES for wedge n is calculated. This element is also shown by the mathematical relationship set forth below:

WORFi(n)=WORFcurrent(n)+WORFi−1(n)

Next, a decision tree is used to determine if the final conditions are met, as depicted by reference number 722. The final conditions for the proposed method 700 are revolution number independent. In one embodiment, the WORF computation method 700 is terminated after a predetermined number of servo wedges from the start of the procedure. The method 700 may also be terminated after a desired level or ratio of RRO reduction is achieved. The method 700 may be terminated or paused by a qualifying event, such as start of a seek, servo position bump detection (off-track drift) or an external disturbance. A qualifying event may be triggered by one of several incidents. For example, an indication of vibration might be another qualifying event that may be triggered by an excessive number of track crossings occurring over a selected amount of time in the absence of a seek command. In another embodiment, a vibration is sensed by an accelerometer that is attached to the housing or to a printed circuit board attached to the housing of the disk drive 100. When the accelerometer has certain output indicative of an acceleration or vibration, this serves as a vibration which is a qualifying event. Of course, it should be noted that other criteria may be termed a qualifying event. Other termination criteria are also possible. In one embodiment, the WORF computation procedure could run indefinitely and not have termination criteria. In other words, the WORF computation would run throughout the life of the drive 100, which would include during the servo writing process, or during the testing time before shipping the drive to a customer (such as during self test or burn in) as well as when the drive is installed and used by the customer. Alternatively, the WORF computation procedure or method 700 could be used at various times during the life of the drive. For example, the WORF computation procedure or method 700 could be used as part of a data recovery procedure. Generally, when information representing data can not be retrieved during the normal operation of the drive, the controller generally will implement a set of data recovery techniques. Many times these data recovery techniques are divided into techniques that are generally successful and into further techniques, generally referred to as deep data recovery techniques, that may be used to recover the data before marking the sector or sectors as bad and placing them on a defect list for skipping. The WORF computation procedure or method 700 may be used as a deep data recovery technique, for example.

If the final conditions 722 are not met, the value of m is incremented by 1, as depicted by reference number 724, and the gain value, G, is adjusted, as depicted by the reference number 726. Several of the elements of the WORF computation procedure or method 700 are then repeated, starting at the element 714.

The WORF computation procedure or method 700 provides usable WORF values for a new servo track location in a relatively short time, when compared to other WORF determination techniques. Using the WORF computation procedure or method 700, the updated WORF values are available immediately after the corresponding wedge and this reduces the time between the measurement of the PES data and the use of correction values derived from this data. The WORF computation procedure or method 700 converges quickly and can be more stable than other methods. The WORF computation procedure or method 700 also lessens the computational overhead as well as the firmware implementation complexity associated with methods of performing the convolutions for all the wedges on the track sequentially after the collection of PES data for the entire revolution or multiple revolutions. The fact that WORF determination for each servo wedge has to be finished before the start of the next servo interrupt poses extra hardware requirement: the processor has to be fast enough to finish required computations in the time between the end of the first servo interrupt and the start of second servo interrupt.

Using the WORF computation procedure or method 700, the WORF values for every servo wedge is computed using the exact same set of steps. There are no distinct data collection and distinct data processing stages using the WORF computation procedure or method 700. This allows simpler and smaller lines of code implementation and does not require a WORF processing state machine running in the background. This WORF scheme is very naturally implemented completely in real time servo interrupt routine.

FIG. 8 is a method 800 for locating a track on a disk surface having a plurality of wedges of servo information, according to an example embodiment. The method 800 for locating a track on a disk surface having a plurality of wedges of servo information includes demodulating servo information for a first servo wedge 810, and determining a correction factor for a written in repeatable runout for the servo information for the first servo wedge before demodulating servo information for a second servo wedge 812. The second servo wedge is the next servo wedge in time with respect to the first servo wedge. The correction factor for the first servo wedge is added to a position error signal for the first servo wedge. The position error signal is found by demodulating the servo information for the first servo wedge. In some embodiments, the determined correction factor for the first wedge of servo information is stored in memory 814. In some embodiments, storing the determined correction factor for the first wedge of servo information includes storing the value on the surface of the disk, while in other embodiments, the correction factor is stored in memory off the disk surface. In some embodiments, determining the correction factor for a written in repeatable runout for the servo information for the first servo wedge includes a convolution of values from each of the plurality of servo wedges resulting from demodulating servo information for each of the plurality of servo wedges. The convolution requires the position error signal for each of the plurality of servo wedges on the track. As a result, the method includes retrieving a position error signal for each of the plurality of servo wedges on the track from storage 816. In some embodiments, the method 800 for determining the correction value is performed at times when the customer is operating the drive. One such time is during data recovery.

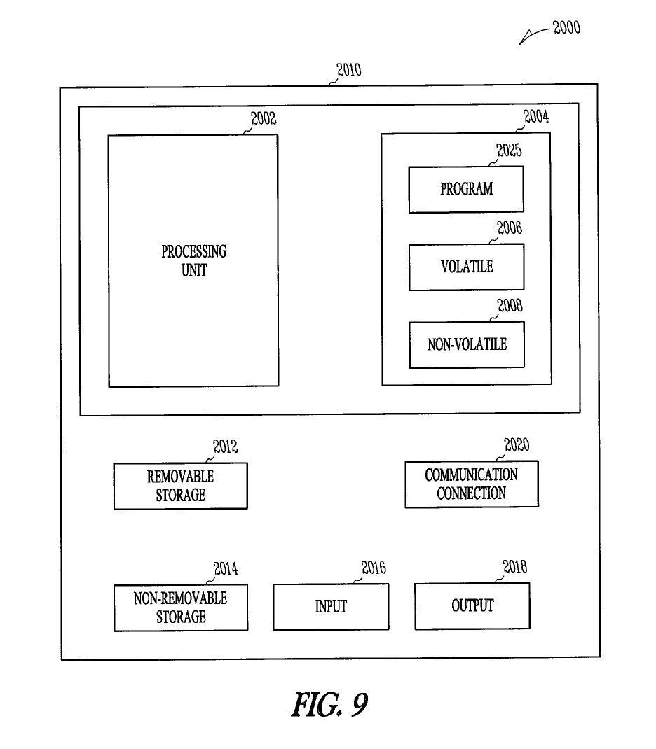

FIG. 9 is a block diagram of a computer system 2000 that executes programming for performing the above methods 700 and 800 shown in FIGS. 7 and 8, according to an example embodiment. A general computing device in the form of a computer 2010, may include a processing unit 2002, memory 2004, removable storage 2012, and non-removable storage 2014. Memory 2004 may include volatile memory 2006 and non-volatile memory 2008. Computer 2010 may include, or have access to a computing environment that includes, a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. One of the inputs could be a keyboard, a mouse, or other selection device. The communication connection 2020 can also include a graphical user interface, such as a display. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2002 of the computer 2010. A hard drive, CD-ROM, and RAM are some examples of articles including a computer-readable medium. For example, a computer program 2025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 2000 to provide generic access controls in a COM based computer network system having multiple users and servers.

A machine-readable medium, such as discussed above, provides instructions that, when executed by a machine, cause the machine to demodulate servo information for a first servo wedge, and determine a correction factor for a written in repeatable runout for the servo information for the first servo wedge before demodulating servo information for a second servo wedge. The second servo wedge is next in time with respect to the first servo wedge. In some embodiments, the instructions, when executed by a machine, further cause the machine to add the determined correction factor for the first servo wedge to a position error signal for a first servo wedge. The position error signal results from demodulating the servo information for the first servo wedge. In some embodiments, the instructions cause the machine to store the determined correction factor for the first wedge of servo information. The machine readable medium may also cause the machine to retrieve a plurality of PES values associated with each of a plurality of servo wedges associated with a track on a disk surface of a disk drive, and perform a convolution of the retrieved PES values from each of the plurality of servo wedges as part of determining the correction value. The machine readable medium also may include instructions to cause the machine to add the determined correction factor for the first wedge of servo information to a PES value for the first wedge of servo information. The machine may then be instructed to produce a current in a voice coil motor of the disk drive to move a transducer to a position over a selected track on a disk.

A disk drive includes a disk for storing information representing data, and an actuator including an actuator motor, and a transducer attached to the actuator. The disk includes a plurality of concentric tracks, and a plurality of servo wedges. The plurality of servo wedges includes a first servo wedge and a second servo wedge. Each of the plurality of servo wedges includes servo information crossing the plurality of concentric tracks. The transducer reads the servo information from the first servo wedge and the second servo wedge. The disk drive also includes a demodulator for demodulating information at the first servo wedge. The result of demodulating the servo information includes a determination of a position error signal related to the position of the transducer with respect to a desired track of the plurality of tracks. The disk drive includes a processor for determining a correction factor to correct for written in run out of the information as written in the first servo wedge. The correction factor is determined before demodulating the position error signal for the second servo wedge on the track. The processor adds the correction factor to the position error signal and the result fed back to the actuator motor to position the transducer over a selected track. The disk drive also includes a memory device for storing a plurality of position error signal values associated with demodulating each of the plurality of servo wedges along a track. The processor of the disk drive retrieves the plurality position error signal values from the memory device, and performs a convolution with the plurality of position error signal values as part of determining the correction factor. In one embodiment, the first servo wedge and the second servo wedge are adjacent one another on the surface of the disk. In still other embodiments, the disk drive includes an event detector for detecting events. The processor interrupts the determination of the correction factor in response to an input from the event detector.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for locating a track on a disk surface having a plurality of wedges of servo information comprising:
demodulating servo information for a first servo wedge; and
determining a correction factor for a written in repeatable runout for the servo information for the first servo wedge before demodulating servo information for a second servo wedge, the second servo wedge next in time with respect to the first servo wedge.

2. The method of claim 1 further comprising adding the determined correction factor for the first servo wedge to a position error signal for a first servo wedge, the position error signal resulting from demodulating the servo information for the first servo wedge.

3. The method of claim 1 further comprising storing the determined correction factor for the first wedge of servo information in memory.

4. The method of claim 1 further comprising storing the determined correction factor for the first wedge of servo information on the surface of the disk.

5. The method of claim 1 wherein determining the correction factor for a written in repeatable runout for the servo information for the first servo wedge includes a convolution of values from each of the plurality of servo wedges resulting from demodulating servo information for each of the plurality of servo wedges.

6. The method of claim 5 further comprising retrieving a position error signal for each of the plurality of servo wedges on the track from storage, the position error signal resulting from demodulating the servo information for each of the plurality of servo wedges.

7. The method of claim 1 performed at times when the customer is operating the drive.

8. The method of claim 1 performed as a data recovery technique.

9. A machine-readable medium that provides instructions that, when executed by a machine, cause the machine to:
demodulate servo information for a first servo wedge; and
determine a correction factor for a written in repeatable runout for the servo information for the first servo wedge before demodulating servo information for a second servo wedge, the second servo wedge next in time with respect to the first servo wedge.

10. The machine readable medium of claim 9 wherein the instructions, when executed by a machine, further cause the machine to add the determined correction factor for the first servo wedge to a position error signal for a first servo wedge, the position error signal resulting from demodulating the servo information for the first servo wedge.

11. The machine readable medium of claim 9 wherein the instructions, when executed by a machine, further cause the machine to store the determined correction factor for the first wedge of servo information.

12. The machine readable medium of claim 9 wherein determining the correction factor for a written in repeatable runout for the servo information for the first servo wedge further causes the machine to
retrieve a plurality of PES values associated with each of a plurality of servo wedges associated with a track on a disk surface of a disk drive, the plurality of PES values resulting from demodulating servo information for each of the plurality of servo wedges; and
perform a convolution of the retrieved PES values from each of the plurality of servo wedges.

13. The machine readable medium of claim 9 wherein the instructions, when executed by a machine, further cause the machine to add the determined correction factor for the first wedge of servo information to a PES value for the first wedge of servo information, the PES value resulting from demodulating servo information for the first servo wedge.

14. The machine readable medium of claim 13 wherein the instructions, when executed by a machine, further cause the machine to produce a current in a voice coil motor of the disk drive to move a transducer to a position over a selected track on a disk.

15. A disk drive comprising:
a disk for storing information representing data, the disk further including:
a plurality of concentric tracks;
a plurality of servo wedge, a first servo wedge and a second servo wedge, each of the plurality of servo wedges including servo information crossing the plurality of concentric tracks;
an actuator including an actuator motor;
a transducer for reading servo information from the first servo wedge and the second servo wedge, the transducer attached to the actuator;
a demodulator for demodulating information at the first servo wedge to determine a position error signal related to the position of the transducer with respect to a desired track of the plurality of tracks; and
a processor for determining a correction factor to correct for written in run out of the information as written in the first servo wedge, the correction factor determined before demodulating the position error signal for the second servo wedge on the track, the processor adding the correction factor to the position error signal and the result fed back to the actuator motor to position the transducer over a selected track.

16. The disk drive of claim 15 further comprising a memory device for storing a plurality of position error signal values associated with demodulating each of the plurality of servo wedges along a track.

17. The disk drive of claim 16 wherein the processor
retrieves the plurality position error signal values from the memory device;
performs a convolution with the plurality of position error signal values as part of determining the correction factor.

18. The disk drive of claim 15 wherein the first servo wedge and the second servo wedge are adjacent one another on the surface of the disk.

19. The disk drive of claim 15 further comprising an event detector for detecting events, the processor interrupting the determination of the correction factor in response to an input from the event detector.
